(19) United States
(12) Patent Application Publication
(10) Pub. No.: US 2009/0128111 A1
(43) Pub. Date: May 21, 2009

(54) REVERSE CURRENT PROTECTION APPARATUS FOR A SYNCHRONOUS SWITCHING VOLTAGE CONVERTER

(76) Inventor: Shang-Yu Chang Chien, Kaohsiung County (TW)

Correspondence Address: NORTH AMERICA INTELLECTUAL PROPERTY CORPORATION, P.O. BOX 506, MERRIFIELD, VA, 22116, US

(21) Appl. No.: 11/941,966

(22) Filed: Nov. 19, 2007

(51) Int. Cl. G05F 1/00

(52) U.S. Cl. 323/282

(57) ABSTRACT

A synchronous switching voltage converter that avoids a reverse current is provided. The synchronous switching voltage converter comprises a first switch, a second switch, an inductor, a current sensing unit, and a current comparing unit. A first current flows through the inductor. The current sensing unit provides a second current which is proportional to the first current. The current comparing unit judges whether the first current is equal to zero at time x by comparing A*I₂(x+y) with I₂(x+A*y), where A is a constant satisfying an inequality 0<A<1, y represents a first duration time, I₂(x+y) represents the second current at time (x+y), I₂(x+A*y) represents the second current at time (x+A*y), and the first switch is ON during the first duration time.

### BACKGROUND OF THE INVENTION

1. Field of the Invention

The present invention relates to a synchronous switching voltage converter. More particularly, the present invention relates to a synchronous switching voltage including a reverse current protection apparatus.

2. Description of the Related Art

FIG. 1 is a circuit diagram showing a conventional synchronous switching voltage converter 10. An input voltage Vᵢₙ₁ is coupled to an input terminal IN1 and an output voltage Vₒ₁ is coupled to an output terminal O1. The synchronous switching voltage converter 10 is a boost-type voltage converter which converts the lower input voltage Vᵢₙ₁ into the higher output voltage Vₒ₁. An inductor L1 is coupled between the input terminal IN1 and a switching node N1. A switch SP1 is coupled between the switching node N1 and the output terminal O1. A switch SN1 is coupled between the switching node N1 and a ground. Furthermore, an output capacitor Cₒ₁ is coupled to the output terminal O1 so as to filter ripples of the output voltage Vₒ₁. In the example shown in FIG. 1, the switch SP1 is implemented by a PMOS transistor while the switch SN1 is implemented by a NMOS transistor. A switching control circuit 12 applies a driving signal DN1 to turn ON/OFF the switch SN1, and applies a driving signal DP1 to turn ON/OFF the switch SP1.

More specifically, the switching control circuit 12 adjusts the duty cycles of the driving signals DN1 and DP1 in response to the feedback of the output voltage Vₒ₁, thereby regulating the output voltage Vₒ₁ to a target value. When the output voltage Vₒ₁ is lower than the target value, the duty cycles of the driving signals DN1 and DP1 will be increased so as to raise the output voltage Vₒ₁. When the output voltage Vₒ₁ is larger than the target value, the duty cycles of the driving signals DN1 and DP1 will be decreased so as to reduce the output voltage Vₒ₁.

FIG. 2(A) illustrates a timing chart of a conventional current I_{L1} flowing through the inductor L1 under a heavy loading condition, while FIG. 2(B) illustrates a timing chart of a conventional current I_{L1} flowing through the inductor L1 under a light loading condition. As shown in FIG. 2(A), the current I_{L1} is always larger than zero under the heavy loading condition. A reverse current cannot be observed. However, as shown in FIG. 2(B), the current I_{L1} is lower than zero during time T_{A} to T_{B} under the light loading condition. During this interval, the current I_{L1} will flow from the output terminal O1 to the input terminal IN1, thereby resulting in a reverse current and decreasing the power efficiency.

### SUMMARY OF THE INVENTION

In view of the above-mentioned problem, an object of the present invention is to provide a synchronous switching voltage converter for avoiding a reverse current under the light loading condition, thereby improving the power efficiency.

According to the present invention, the synchronous switching voltage converter comprises a first switch, a second switch, an inductor, a current sensing unit, a current comparing unit, and a time computing unit. A first current flows through the inductor. The current sensing unit provides a second current which is proportional to the first current. The current comparing unit judges if the first current is equal to zero at time x or not by comparing A*I₂(x+y) with I₂(x+A*y), where A is a constant which satisfies an inequality 0<A<1, y represents a first duration time, I₂(x+y) represents the second current at time (x+y), I₂(x+A*y) represents the second current at time (x+A*y), and the first switch is ON during the first duration time. The time computing unit calculates a second duration time T_{PS+1} of the (S+1)th period based on a third current and a third duration time T_{PS} of the Sth period, where S is an integer larger than 1, the third current is proportional to the first current, and the second switch is ON during the second and third duration time.

The current sensing unit, the current comparing unit, and the time computing unit are used for preventing the first current from being lower than zero under the light loading condition, thereby improving the power efficiency.

### BRIEF DESCRIPTION OF THE DRAWINGS

The above-mentioned and other objects, features, and advantages of the present invention will become apparent with reference to the following descriptions and accompanying drawings, wherein:

FIG. 1 is a circuit diagram showing a conventional synchronous switching voltage converter;

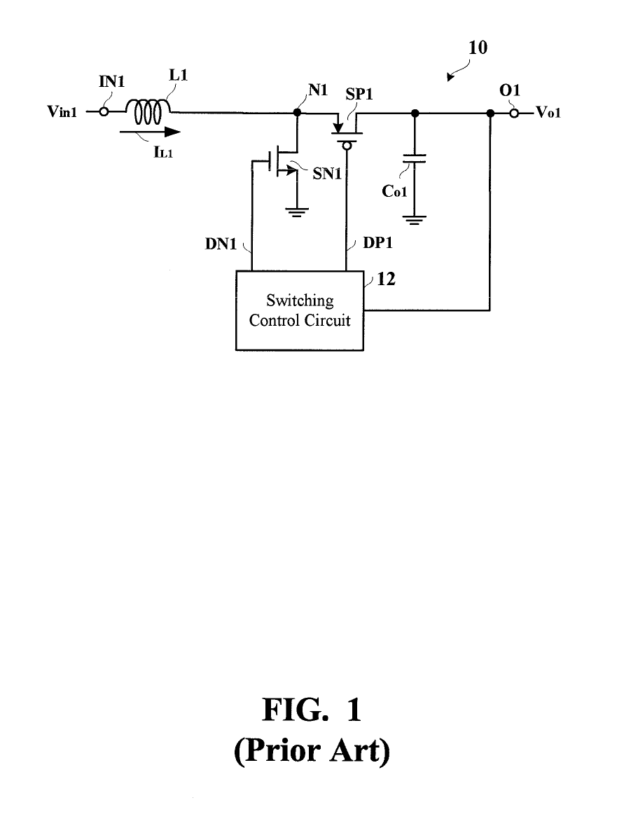

FIGS. 2(A) and 2(B) are timing charts showing the operations of a conventional synchronous switching voltage converter;

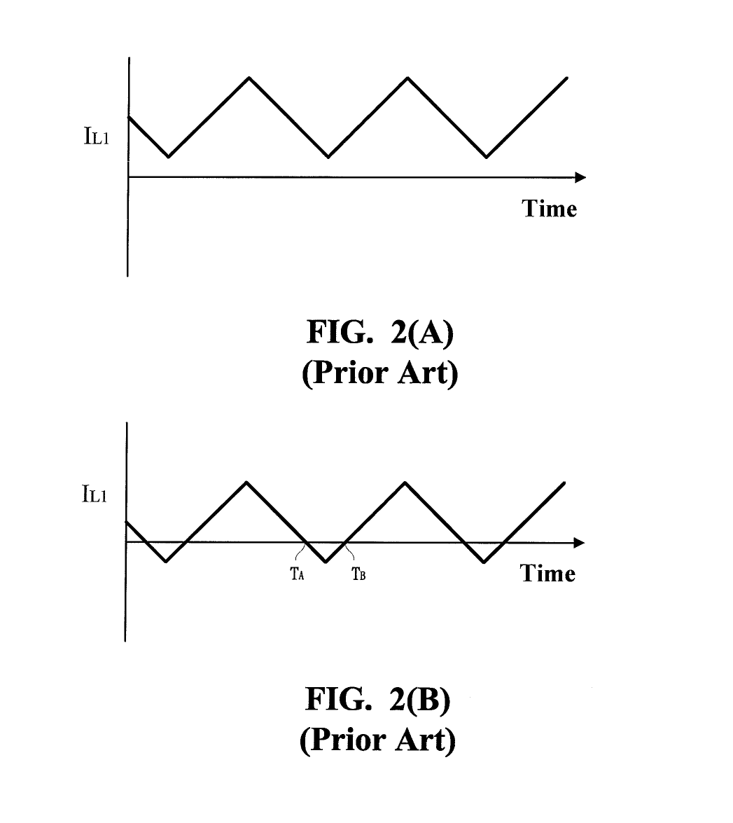

FIG. 3 is a circuit diagram showing a synchronous switching voltage converter according to the present invention;

FIGS. 4(A) and 4(B) are timing charts showing the operations of a synchronous switching voltage converter according to the present invention;

### DETAILED DESCRIPTION OF THE INVENTION

A preferred embodiment according to the present invention will be described in detail with reference to the drawings.

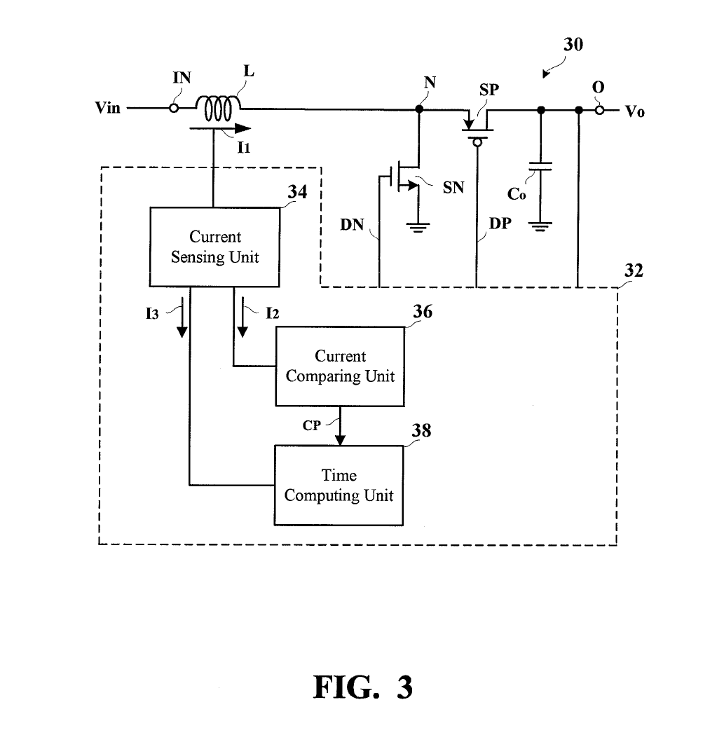

FIG. 3 is a circuit diagram showing a synchronous switching voltage converter 30 according to the present invention. The synchronous switching voltage converter 30 comprises a switching control circuit 32, an inductor L, an output capacitor Cₒ, a switch SP, and a switch SN. An input voltage Vᵢₙ is coupled to an input terminal IN and an output voltage Vₒ is coupled to an output terminal O. The synchronous switching voltage converter 30 is a boost-type voltage converter which converts the lower input voltage Vᵢₙ into the higher output voltage Vₒ. The inductor L is coupled between the input terminal IN and a switching node N, where a current I₁ flows through the inductor L. The switch SP is coupled between the switching node N and the output terminal O. The switch SN is coupled between the switching node N and a ground. Furthermore, both the output capacitor Cₒ and the switching control circuit 32 are coupled to the output terminal O. In the example shown in FIG. 3, the switch SP is implemented by a PMOS transistor while the switch SN is implemented by a NMOS transistor. The switching control circuit 32 applies a driving signal DN to turn ON/OFF the switch SN, and applies a driving signal DP to turn ON/OFF the switch SP.

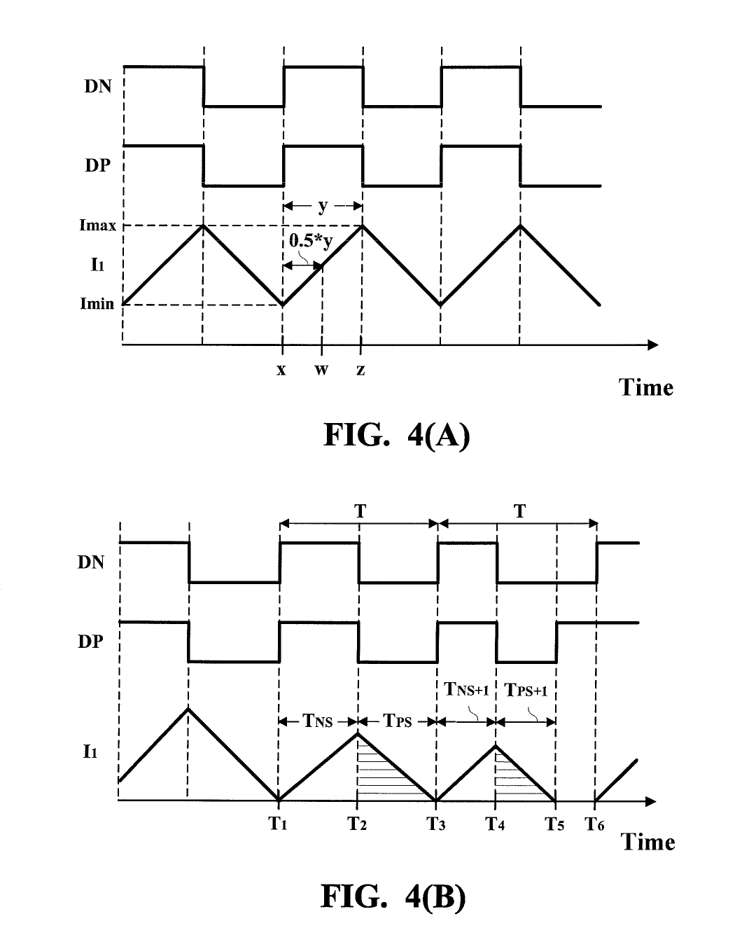

FIG. 4(A) illustrates a timing chart under the heavy loading condition according to the present invention. When the driving signals DN and DP are at a high level, the switch SN is turned ON and the switch SP is turned OFF. The current I₁ increases gradually as a result. When the driving signals DN and DP are at a low level, the switch SN is turned OFF and the switch SP is turned ON. The current I₁ decreases gradually as a result. However, the current is not lower than zero under the heavy loading condition. FIG. 4(B) illustrates a timing chart under the transition from the heavy loading condition to the light loading condition according to the present invention.

As shown in FIG. 3, the switching control circuit 32 comprises a current sensing unit 34, a current comparing unit 36, and a time computing unit 38 so as to prevent the current I₁ from being lower than zero. The current sensing unit 34 provides a current I₂ to the current comparing unit 36 and a current I₃ to the time computing unit 38 based on the current I₁, where I₂=I₃ and I₂ is proportional to I₁. Also, the time computing unit 38 receives a comparing signal CP from the current comparing unit 36. The detailed operation will be described later.

As shown in FIG. 4(A), the switch SN begins to be ON at time x and the current I₁ is at its minimum value Iₘᵢₙ. The switch SN is ON during a duration time y. After the duration time y, the current I₁ is at its maximum value Iₘₐₓ at time z, where z=x+y. In order to avoid the reverse current of the inductor L, the current I₁ is monitored to check at what time Iₘᵢₙ is equal to zero. The current comparing unit 36 is used to judge if the current I₁ is equal to zero at time x by comparing A*I₂(x+y) with I₂(x+A*y), where A is a constant satisfying an inequality 0<A<1. I₂(x+y) represents the current I₂ at time (x+y), and I₂(x+A*y) represents the current I₂ at time (x+A*y). Since I₂ is proportional to I₁, the current comparing unit 36 utilizes I₂ for comparison, where I₂=B*I₁ and B is a constant satisfying an inequality 0<B<1.

In order to be easily implemented, A is chosen to be 0.5 according to the present invention. I₂(x+0.5*y) represents the current I₂ at time w and I₁(x+0.5*y) represents the current I₁ at time w, where w=x+0.5*y. Therefore, I₁(w) is equal to 0.5*(Iₘᵢₙ+Iₘₐₓ). Furthermore, A*I₂(x+y) is equal to 0.5*I₂(x+y), where 0.5*I₂(x+y)=0.5*I₂(z)=0.5*B*Iₘₐₓ. I₂(x+A*y) is equal to I₂(x+0.5*y), where I₂(x+0.5*y)=I₂(w)=0.5*B*(Iₘᵢₙ+Iₘₐₓ). When Iₘᵢₙ is larger than zero, the current comparing unit 36 outputs the comparing signal CP with the low level, representing that I₂(x+A*y) is larger than A*I₂(x+y). When Iₘᵢₙ is equal to zero, the current comparing unit 36 outputs the comparing signal CP with the high level, representing that I₂(x+A*y) is equal to A*I₂(x+y), and the current I₁ is equal to zero at time x.

As shown in FIG. 4(B), the period of the driving signal DN and DP is T. T₁ is the starting time of the Sth period, which indicates that T₁ is equal to (S−1)*T, where S is an integer larger than 1. Also, the current I₁ is equal to zero at time T₁, under the light loading condition. The switch SN is ON during a duration time T_{NS}. After the duration time T_{NS}, the current comparing unit 36 outputs the comparing signal CP with the high level at time T₂ to the time computing unit 38, indicating that the current I₁ is equal to zero at time T₁, where T₂=T₁+T_{NS}. As mentioned before, since I₃ is also equal to B*I₁, the time computing unit 38 utilizes I₃ for calculation. When the time computing unit 38 receives the comparing signal CP with the high level, the time computing unit 38 stores the current I₃ at time T₂ (i.e., I₃(T₂)). Then the switch SP is ON during a duration time T_{PS}. After the duration time T_{PS}, the current I₁ is equal to zero at time T₃, where T₃=T₂+T_{PS}. Time T₃ is the ending time of the Sth period. Also, time T₃ is the starting time of the (S+1)th period. At this moment the time computing unit 38 stores the duration time T_{PS} of the Sth period. Then the switch SN is ON during a duration time T_{NS+1}. After the duration time T_{NS+1}, the time computing unit 38 stores the current I₃ at time T₄ (i.e., I₃(T₄)), where T₄=T₃+T_{NS+1}. To prevent the current I₁ from being lower than zero after time T₅, the time computing unit 38 calculates a duration time T_{PS+1} of the (S+1)th period based on I₃(T₂), I₃(T₄) and T_{PS}, where T₅=T₄+T_{PS+1}. Note that the switch SP is ON during the duration time T_{PS+1}. Finally, the switching control circuit 32 outputs the driving signal DP with the high level so as to turn OFF the switch SP according to the duration time T_{PS+1}, resulting that the current I₁ keeps zero during time T₅ to T₆, where time T₆ is the ending time of the (S+1)th period. At this moment the synchronous switching voltage converter 30 operates in a discontinuous current mode and a reverse current can be avoided. Since the current I₁ decreases at a fixed slope, the triangle constructed by T₂/T₃/I₁(T₂) is similar to the triangle constructed by T₄/T₅/I₁(T₄), as depicted in FIG. 4(B), where I₁(T₂) indicates the current I₁ at time T₂ and I₁(T₄) indicates the current I₁ at time T₄. Therefore, the duration time T_{PS+1} can be obtained, where T_{PS+1}=T_{PS}*I₁(T₄)/I₁(T₂)=T_{PS}*I₃(T₄)/I₃(T₂). In the same manner, the time computing unit 38 calculates a duration time T_{PS+2} of the (S+2)th period, a duration time T_{PS+3} of the (S+3)th period, and so on.

To sum up, the switching control circuit 32 generates the driving signal DP based on the duration time T_{PS+1} calculated by the time computing unit 38, in order that a reverse current flowing through the inductor L can be avoided, thereby improving the power efficiency. Also, the synchronous switching voltage converter 30 operates in a discontinuous current mode under the light loading condition. The present invention can be applied for not only the boost-type voltage converter but also the buck-type voltage converter.

While the invention has been described by a preferred embodiment, it is to be understood that the invention is not limited to the disclosed embodiment. On the contrary, it is intended to cover various modifications. Therefore, the scope of the appended claims should be accorded the broadest interpretation so as to encompass all such modifications.

What is claimed is:

1. A switching voltage converter comprising:
a switching node;
a first switch coupled to the switching node;
a second switch coupled to the switching node;
an inductor coupled to the switching node, wherein a first current flows through the inductor;
a current sensing unit for providing a second current, the second current being proportional to the first current; and
a current comparing unit for judging if the first current is equal to zero at time x by comparing A*I₂(x+y) with I₂(x+A*y), wherein:
A is a constant satisfying an inequality 0<A<1, y represents a first duration time, I₂(x+y) represents the second current at time (x+y), I₂(x+A*y) represents the second current at time (x+A*y), and the first switch is ON during the first duration time.

2. The switching voltage converter of claim 1, further comprising:
a time computing unit for calculating a second duration time of the (S+1)th period based on a third current and a third duration time of the Sth period, wherein S is an integer larger than 1, the third current is proportional to the first current, and the second switch is ON during the second and third duration time.

3. The switching voltage converter of claim 1, wherein A is equal to 0.5:

4. The switching voltage converter of claim 1, wherein the switching voltage converter is a boost-type voltage converter.

5. The switching voltage converter of claim 2, wherein the current comparing unit generates a comparing signal to the time computing unit so as to indicate that the switching voltage converter operates under a light loading condition.

6. The switching voltage converter of claim 5, wherein the current sensing unit, the current comparing unit, and the time computing unit are used for preventing the first current from being lower than zero under the light loading condition.

7. The switching voltage converter of claim 2, wherein the switching voltage converter operates in a discontinuous current mode under a light loading condition.
